(19) United States
(12) Patent Application Publication
(10) Pub. No.: US 2025/0226631 A1
(43) Pub. Date: Jul. 10, 2025

(54) CONNECTION STRUCTURE AND ASSEMBLY

(71) Applicant: Yazaki Corporation, Tokyo (JP)

(72) Inventor: Yasuhiro KOMINATO, Makinohara-shi (JP)

(73) Assignee: Yazaki Corporation, Tokyo (JP)

(21) Appl. No.: 19/013,452

(22) Filed: Jan. 8, 2025

(30) Foreign Application Priority Data
Jan. 10, 2024 (JP) 2024-001824

(51) Int. Cl. H01R 33/90; H01M 50/204

(52) U.S. Cl. CPC H01R 33/90; H01M 50/204; H01M 2220/20

(57) ABSTRACT

A connection structure of an embodiment is a connection structure that electrically connects a device and a battery pack. The connection structure includes a first conductor, a second conductor, and a third conductor. The first conductor is connected to one of the device and the battery pack. The second conductor is connected to the other of the device and the battery pack. The second conductor is arranged so as to be spaced away from the first conductor in a first direction. The third conductor is configured to electrically connect the first conductor and the second conductor by being inserted between the first conductor and the second conductor from a second direction intersecting the first direction in a state where the device and the battery pack are fixed.

### BACKGROUND OF THE INVENTION

### Field of the Invention

Embodiments of the present invention relate to a connection structure and an assembly.

This application claims priority to Japanese Patent Application No. 2024-001824 filed in Japan on Jan. 10, 2024, the contents of which are incorporated herein by reference.

### Description of Related Art

A structure in which a battery pack and a device are connected is known. For example, Japanese Unexamined Patent Application, First Publication No. 2018-144524 discloses a structure in which a battery module is connected to a fuse contactor unit of an electric vehicle.

### SUMMARY OF THE INVENTION

In the assembly disclosed in Japanese Unexamined Patent Application, First Publication No. 2018-144524, a male-side power supply-side terminal provided in a battery module is directly attached to and detached from each of a plurality of female-side power reception-side terminals provided in a fuse contactor unit. In such a connection structure in which the power reception-side terminal and the power supply-side terminal are directly attached and detached, it may be difficult to improve assemblability.

An object of an embodiment of the present invention is to provide a connection structure and an assembly that achieve improvement in assemblability.

A connection structure according to an embodiment of the present invention is a connection structure for electrically connecting a device and a battery pack. The connection structure includes a first conductor, a second conductor, and a third conductor. The first conductor is connected to one of the device and the battery pack. The second conductor is connected to the other of the device and the battery pack. The second conductor is arranged so as to be spaced away from the first conductor in a first direction. The third conductor is configured to electrically connect the first conductor and the second conductor by being inserted between the first conductor and the second conductor from a second direction intersecting the first direction in a state where the device and the battery pack are fixed.

An assembly according to an embodiment of the present invention includes a device, a battery pack, and a connection structure. The connection structure is configured to electrically connect the device and the battery pack. The connection structure includes a first conductor, a second conductor, and a third conductor. The first conductor is connected to one of the device and the battery pack. The second conductor is connected to the other of the device and the battery pack. The second conductor is arranged so as to be spaced away from the first conductor in the first direction. The third conductor is configured to electrically connect the first conductor and the second conductor by being inserted between the first conductor and the second conductor from a second direction intersecting the first direction in a state where the device and the battery pack are fixed.

According to one embodiment of the present invention, improvement in assemblability can be easily achieved.

### BRIEF DESCRIPTION OF THE DRAWINGS

FIG. 1 is a front view illustrating an assembly of a first embodiment.

FIG. 2 is a perspective view for describing a connection structure of the first embodiment.

FIG. 3 is a perspective view illustrating a connection unit of the first embodiment.

FIG. 4 is a partially exploded perspective view of the connection unit of the first embodiment.

FIG. 5 is a plan view for describing the connection unit of the first embodiment.

FIG. 6 is a cross-sectional view for describing a method of manufacturing the assembly of the first embodiment.

FIG. 7 is a cross-sectional view for describing the method of manufacturing the assembly of the first embodiment.

FIG. 8 is a cross-sectional view for describing the method of manufacturing the assembly of the first embodiment.

FIG. 9 is a perspective view illustrating a connection unit of a first modification of the first embodiment.

FIG. 10 is a perspective view for describing a connection structure of a second modification of the first embodiment.

FIG. 11 is a perspective view for describing a connection structure of a third modification of the first embodiment.

FIG. 12 is a cross-sectional view for describing the connection structure of the third modification of the first embodiment.

FIG. 13 is a perspective view for describing a connection structure of a fourth modification of the first embodiment.

FIG. 14 is a cross-sectional view for describing a connection structure of a fifth modification of the first embodiment.

FIG. 15 is a cross-sectional view illustrating an assembly of a second embodiment.

FIG. 16 is a perspective view illustrating the assembly of the second embodiment.

### DETAILED DESCRIPTION OF THE INVENTION

Hereinafter, embodiments will be described with reference to the drawings. In the following description, constitutions having the same or similar functions are denoted by the same reference numbers. Redundant descriptions of these constitutions may be omitted. In the present disclosure, the terms are defined as follows. “Connection” is not limited to a mechanical connection, and may include an electrical connection. That is, “connection” is not limited to a case where two elements to be connected are directly connected, and may include a case where two elements to be connected are connected with another element interposed therebetween.

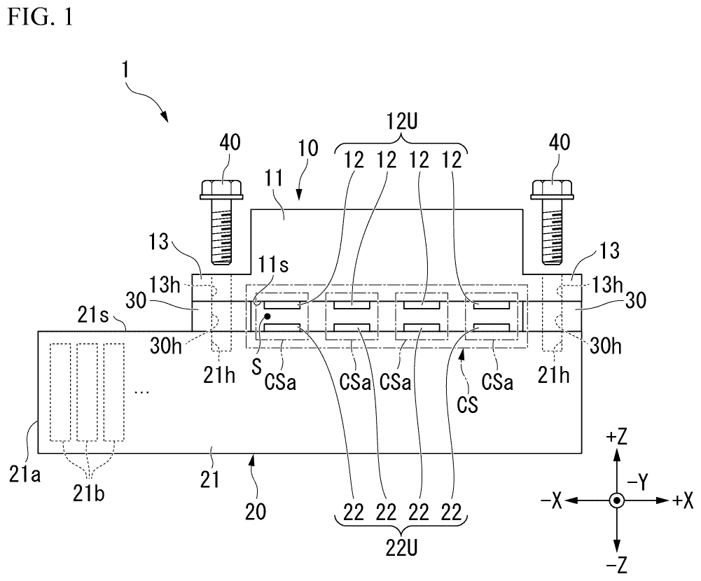

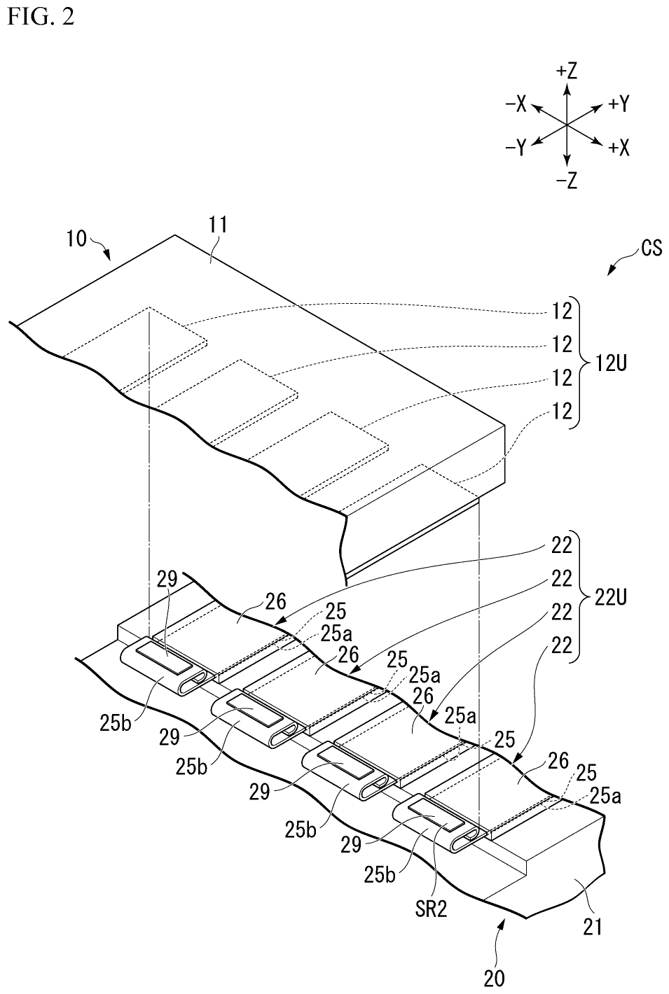

In the present disclosure, the −Z direction, the +Z direction, the −X direction, the +X direction, the −Y direction, and the +Y direction are defined as follows. The −Z direction is a direction from a device 11 (to be described later) toward a battery pack 21 (to be described later) (see FIG. 1). The +Z direction is a direction opposite to the −Z direction. When no distinction is made between the −Z direction and the +Z direction, the direction is simply referred to as “Z direction”. The −X direction and the +X direction are directions intersecting (e.g., orthogonal to) the Z direction. The −X direction is one direction in which a plurality of device bus bars 12 (to be described later) are arranged (see FIG. 1). The +X direction is a direction opposite to the −X direction. When no distinction is made between the −X direction and the +X direction, the direction is simply referred to as “X direction”. The −Y direction and the +Y direction are directions intersecting (e.g., orthogonal to) the Z direction and the X direction. The −Y direction is one direction in which the device bus bar 12 (to be described later) extends (see FIG. 2). The +Y direction is a direction opposite to the −Y direction. When no distinction is made between the −Y direction and the +Y direction, the direction is simply referred to as “Y direction”. In the embodiment described below, the −Z direction is an example of a “first direction”. The Y direction is an example of a “second direction”. The X direction is an example of a “third direction”.

### First Embodiment

### 1. Constitution of Assembly

First, the constitution of an assembly 1 of a first embodiment will be described.

FIG. 1 is a front view illustrating the assembly 1 of the first embodiment. Note that in FIG. 1, illustration of some components is omitted for convenience of description. The assembly 1 is a structure in which a plurality of modules (e.g., device 11 and battery pack 21) are integrated. The assembly 1 is mounted on a mobility unit such as an electric vehicle, for example. The assembly 1 includes, for example, a device unit 10, a battery unit 20, a spacer 30, and a fixing member 40.

### 1.1 Device Unit

First, the device unit 10 will be described. The device unit 10 includes, for example, the device 11, a conductor 12U, and a flange 13.

### Device

The device 11 has a function related to electric power. The device 11 has, for example, one or more functions such as power relay, distribution, cutoff (protection), conversion, charging, or the like. The device 11 is, for example, a high-voltage device such as a junction box, an on-board charger, or a DC-DC converter. Note, however, that the device 11 is not limited to the above examples.

The device 11 has, for example, an installation surface 11s. The installation surface 11s is located at the −Z direction-side end of the device 11. The installation surface 11s is a surface facing the −Z direction. The installation surface 11s is, for example, a plane along the X direction and the Y direction. The installation surface 11s is formed of an insulating material.

### Conductor

The conductor 12U is connected to the device 11. In the present embodiment, the conductor 12U includes a plurality of (e.g., three or more) bus bars 12. Hereinafter, for convenience of description, the conductor 12U is referred to as a “device conductor 12U”. In addition, the bus bar 12 is referred to as a “device bus bar 12”. In the present embodiment, the device conductor 12U is an example of a “first conductor”. The device bus bar 12 is an example of a “first conductive member”.

The device bus bar 12 is a conductive member connected to the device 11. The device bus bar 12 is electrically connected to an electrode included in the device 11. In the present embodiment, a plurality of (e.g., three or more) device bus bars 12 are attached to the installation surface 11s of the device 11. The plurality of device bus bars 12 are arranged side by side in the X direction at intervals on the installation surface 11s. Each of the plurality of device bus bars 12 extends in the Y direction. The device bus bar 12 is formed of a conductive material such as metal. Note that details of the device bus bar 12 will be described later.

### Flange

The flange 13 is an overhanging portion provided in the device 11. The flange 13 is molded integrally with the device 11, for example. The pair of flanges 13 protrude from the device 11 to both sides in the X direction, for example. The flange 13 has a through hole 13h. The through hole 13h penetrates the flange 13 in the Z direction. The fixing member 40 (to be described later) is inserted into the through hole 13h from the +Z direction. Note that the flange 13 may be provided as part of the device 11. If another fixing structure is provided, the flange 13 may be omitted.

### 1.2 Battery Unit

Next, the battery unit 20 will be described. The battery unit 20 includes, for example, the battery pack 21 and a conductor 22U.

### Battery Pack

The battery pack 21 is a device including a plurality of battery cells 21b. The battery pack 21 includes, for example, a battery case 21a and the plurality of battery cells 21b. The battery case 21a is formed of an insulating material. The plurality of battery cells 21b are accommodated in the battery case 21a. The plurality of battery cells 21b are electrically connected in series, for example. The battery pack 21 has, for example, an installation surface 21s and an engagement hole 21h.

The installation surface 21s is located at the +Z direction-side end of the battery pack 21. The installation surface 21s is a surface facing the +Z direction. The installation surface 21s is, for example, a plane along the X direction and the Y direction. The installation surface 21s is formed of an insulating material.

The engagement hole 21h is provided at a position corresponding to the through hole 13h of the flange 13 of the device unit 10. The engagement hole 21h is opened on the installation surface 21s. The engagement hole 21h extends in the −Z direction from the installation surface 21s. The engagement hole 21h has a female screw. The fixing member 40 passed through the through hole 13h of the flange 13 of the device unit 10 is engaged with the engagement hole 21h.

### Conductor

The conductor 22U is a conductor connected to the battery pack 21. In the present embodiment, the conductor 22U includes a plurality of (e.g., three or more) bus bars 22. Hereinafter, for convenience of description, the conductor 22U is referred to as a “battery conductor 22U”. In addition, the bus bar 22 is referred to as a “battery bus bar 22”. In the present embodiment, the battery conductor 22U is an example of a “second conductor”. The battery bus bar 22 is an example of a “second conductive member”.

The battery bus bar 22 is a conductive member connected to the battery pack 21. The battery bus bars 22 are electrically connected to electrodes of the plurality of battery cells 21b included in the battery pack 21. In the present embodiment, a plurality of (e.g., three or more) battery bus bars 22 are attached to the installation surface 21s of the battery pack 21. The plurality of battery bus bars 22 are arranged side by side in the X direction at intervals on the installation surface 21s. Each of the plurality of battery bus bars 22 extends in the Y direction. The battery bus bar 22 is arranged so as to be spaced away from the device bus bar 12 in the −Z direction. The battery bus bar 22 is formed of a conductive material such as metal. In addition, details regarding the battery bus bar 22 will be described later.

### 1.3 Spacer

The spacer 30 is a member that forms, between the device bus bar 12 and the battery bus bar 22, a space S into which a connection unit 50 (to be described later) is inserted. For example, the spacer 30 is arranged between the device unit 10 and the battery unit 20 in the Z direction. By providing the spacer 30, the device bus bar 12 and the battery bus bar 22 are arranged so as to be spaced away from each other in the Z direction. Note that the spacer 30 may be provided integrally with any one of the device 11, the flange 13, and the battery pack 21. In addition, when the device bus bar 12 and the battery bus bar 22 are arranged so as to be spaced away from each other in the Z direction by another structure, the spacer 30 may be omitted.

In the present embodiment, the spacer 30 has a through hole 30h. The through hole 30h is provided at a position corresponding to the through hole 13h of the flange 13 of the device unit 10. The through hole 30h penetrates the spacer 30 in the Z direction. The fixing member 40 passed through the through hole 13h of the flange 13 of the device unit 10 is inserted into the through hole 30h.

### 1.4 Fixing Member

The fixing member 40 is a member that fixes the device 11 and the battery pack 21. The fixing member 40 is, for example, a fastening member such as a bolt. In the present embodiment, the fixing member 40 is inserted into the through hole 13h of the flange 13 of the device unit 10 from the +Z direction, passes through the through hole 30h of the spacer 30, and is engaged with the engagement hole 21h of the battery pack 21. The fixing member 40 passed through the through hole 13h of the device unit 10 is engaged with the engagement hole 21h of the battery pack 21, whereby the device 11 and the battery pack 21 are fixed (fastened, for example). In the present embodiment, the fixing member 40 passed through the through hole 13h of the device unit 10 is engaged with the engagement hole 21h of the battery pack 21, whereby the device unit 10 and the battery unit 20 are fastened together. The device unit 10 and the battery unit 20 are integrated by thus being fastened together.

Note that in the present disclosure, “fixing the device and the battery pack” is not limited to the case where the device 11 and the battery pack 21 are directly fixed. “Fixing the device and the battery pack” may correspond to a case where the device 11 and the battery pack 21 are fixed with the above-described spacer 30 interposed therebetween. In addition, “fixing the device and the battery pack” may correspond to, for example, a case where the device 11 and the battery pack 21 are both fixed to a common coupling member to indirectly fix the device 11 and the battery pack 21 to the coupling member via a coupling member.

### 2. Connection Structure

Next, a connection structure CS provided in the assembly 1 will be described. The connection structure CS is a connection structure that electrically connects the device 11 and the battery pack 21. The connection structure CS is, for example, a structure that electrically connects a plurality of (e.g., three or more) device bus bars 12 and a plurality of (e.g., three or more) battery bus bars 22. In the present embodiment, the connection structure CS electrically connects the plurality of device bus bars 12 and the plurality of battery bus bars 22 in a one-to-one relationship. In the connection structure CS, for example, the plurality of device bus bars 12 and the plurality of battery bus bars 22 can be connected by a collective operation.

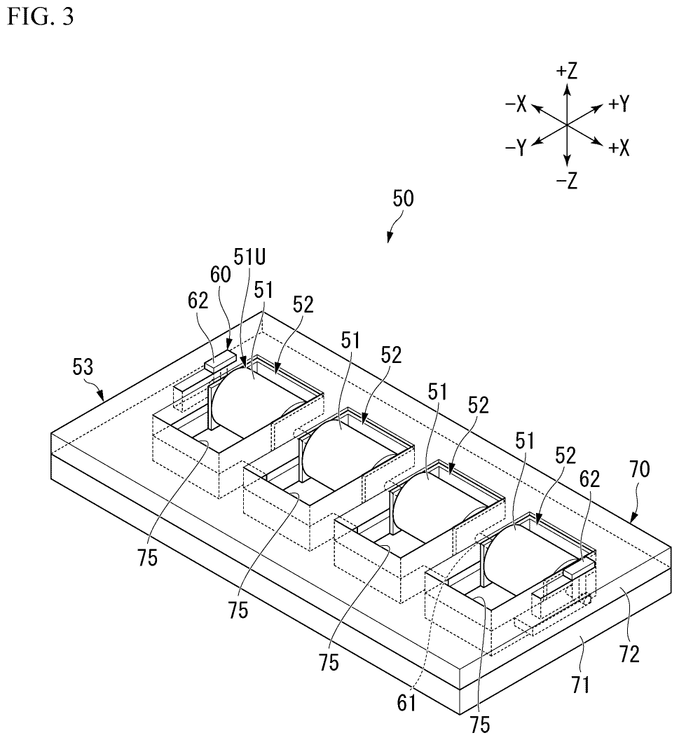

As illustrated in FIG. 1, in the present embodiment, the connection structure CS includes a plurality of connectors CSa electrically independent from each other. Each connector CSa is a connection structure that electrically connects one device bus bar 12 and one battery bus bar 22. Each connector CSa includes, for example, one device bus bar 12, one battery bus bar 22, and one conductive connection member 51 (see FIG. 3) (to be described later). The plurality of connectors CSa are arranged side by side in the X direction at intervals. In the present embodiment, the plurality of connectors CSa have the same constitution.

FIG. 2 is a perspective view for describing the connection structure CS. Note that in FIG. 2, illustration of some components is omitted for convenience of description. The connection structure CS includes the device conductor 12U, the battery conductor 22U, and the connection unit 50 (to be described later). Note that an example in which the connection unit 50 is attached to the device 11 will be described below. Note, however, that instead of the above example, the connection unit 50 may be attached to the battery pack 21. The content of this example will be described later as a modification.

### 2.1 Device Conductor

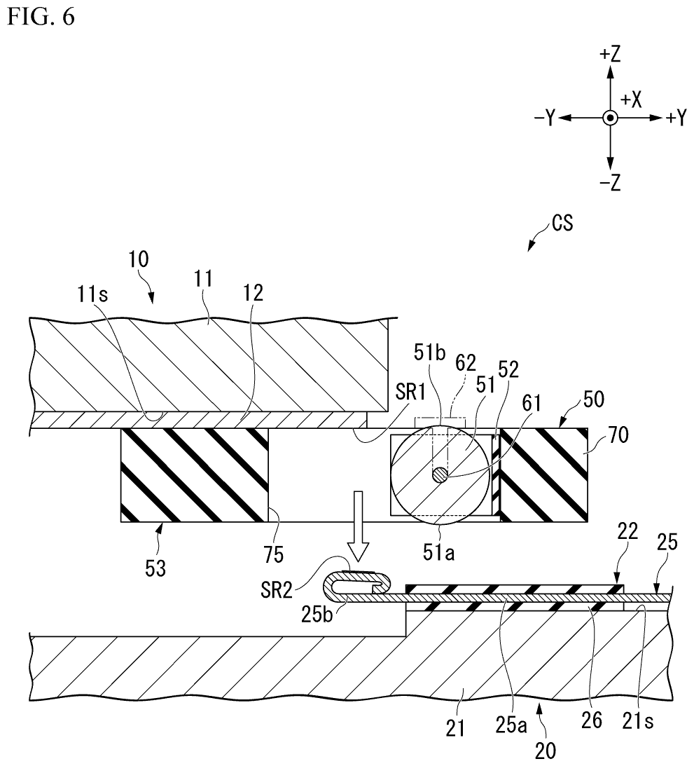

As described above, the device conductor 12U is a conductor connected to the device 11. In the present embodiment, the device conductor 12U includes four device bus bars 12. The four device bus bars 12 are arranged side by side in the X direction at intervals. The device bus bar 12 is, for example, a flat integrated metal plate. The device bus bar 12 extends, for example, along the installation surface 11s of the device 11. A surface of the device bus bar 12 has a receiving surface SR1 which abuts the conductive connection member 51 (to be described later) (see FIG. 6). The receiving surface SR1 is, for example, a plane along the X direction and the Y direction.

### 2.2 Battery Conductor

As described above, the battery conductor 22U is a conductor connected to the battery pack 21. In the present embodiment, the battery conductor 22U includes four battery bus bars 22. Each battery bus bar 22 overlaps at least part of the corresponding device bus bar 12 when viewed in the Z direction.

In the present embodiment, the battery bus bar 22 includes, for example, a metal plate 25 and an insulator 26. The metal plate 25 is a member forming a conductive path of the battery bus bar 22. The metal plate 25 includes, for example, a flat plate 25a and a leaf spring 25b.

The flat plate 25a is a flat integrated metal plate. The flat plate 25a extends along the Y direction. The flat plate 25a is electrically connected to an electrode inside the battery pack 21. Part of the flat plate 25a is covered with the insulator 26.

The leaf spring 25b is provided at an end of the flat plate 25a. For example, the leaf spring 25b is provided at the-Y direction-side end of the flat plate 25a. The leaf spring 25b is formed, for example, by bending part of the metal plate 25. The leaf spring 25b is elastically deformable in the-Z direction which is a direction away from the device bus bar 12. The leaf spring 25b is an example of a “receiver”.

The leaf spring 25b has a receiving surface SR2 which abuts the conductive connection member 51 (to be described later) (see FIG. 6). In the present embodiment, the receiving surface SR2 is inclined with respect to the Y direction so as to be positioned on the −Z direction side toward the +Y direction (see FIG. 6). In addition, the receiving surface SR2 may be a plane along the X direction and the Y direction. In the present embodiment, the receiving surface SR2 has a protrusion 29 protruding in the +Z direction. The protrusion 29 is formed in a flat shape. The protrusion 29 is a contactor (indent) that abuts the conductive connection member 51.

### 2.3 Connection Unit

Next, the connection unit 50 will be described.

FIG. 3 is a perspective view illustrating the connection unit 50. The connection unit 50 is a structure for electrically connecting the device conductor 12U and the battery conductor 22U.

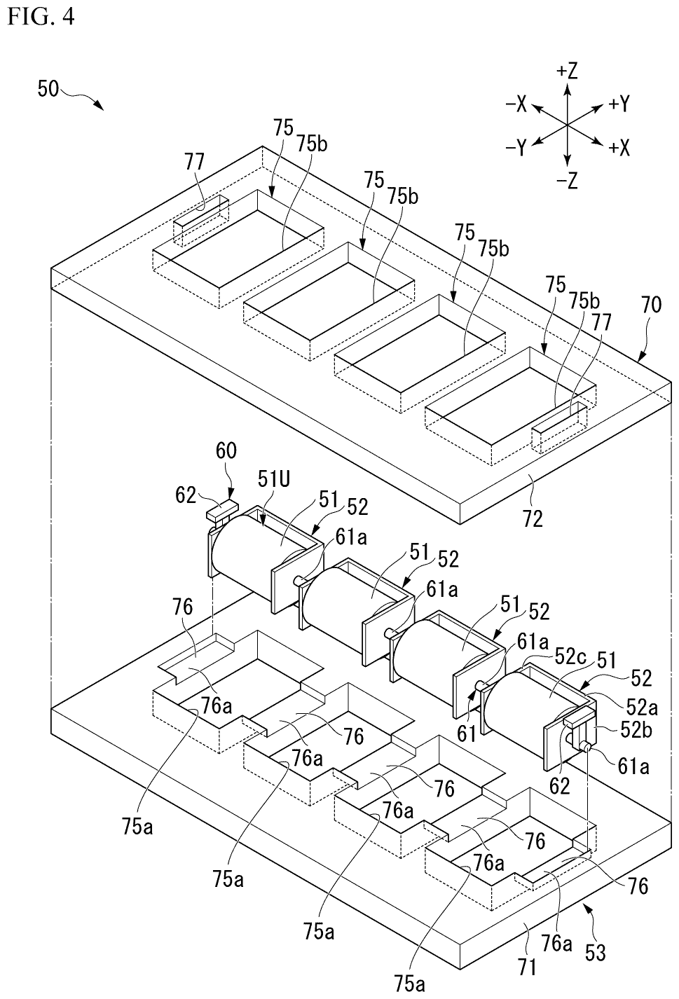

FIG. 4 is a partially exploded perspective view of the connection unit 50. The connection unit 50 includes, for example, a connecting conductor 51U, a plurality of insulating covers 52, and a holder 53.

### Connecting Conductor

The connecting conductor 51U is a conductive portion that electrically connects the device conductor 12U and the battery conductor 22U. As will be described in detail later, the connecting conductor 51U electrically connects the device conductor 12U and the battery conductor 22U by being inserted between the device conductor 12U and the battery conductor 22U from the Y direction in a state where the device 11 and the battery pack 21 are fixed. The connecting conductor 51U is an example of a “third conductor”.

In the present embodiment, the connecting conductor 51U is inserted between the device conductor 12U and the leaf spring 25b of the battery conductor 22U from the Y direction in a state where the device 11 and the battery pack 21 are fixed. With this insertion, the connecting conductor 51U electrically connects the device conductor 12U and the battery conductor 22U in a state where the leaf spring 25b of the battery conductor 22U is elastically deformed in the −Z direction.

In the present embodiment, the connecting conductor 51U includes a plurality of (e.g., three or more) conductive connection members 51. Each conductive connection member 51 is a conductive member that electrically connects one device bus bar 12 and one battery bus bar 22. Each conductive connection member 51 is slidable in the Y direction by a moving mechanism 60 (to be described later). Each conductive connection member 51 is slid in the Y direction by the moving mechanism 60 and is inserted between the device bus bar 12 and the battery bus bar 22 from the Y direction. The conductive connection member 51 is an example of a “third conductive member”.

In the present embodiment, the connection unit 50 includes four conductive connection members 51. The four conductive connection members 51 are arranged side by side in the X direction at intervals. The four conductive connection members 51 are arranged between the four device bus bars 12 and the four battery bus bars 22. The four conductive connection members 51 electrically connect the four device bus bars 12 and the four battery bus bars 22 in a one-to-one relationship.

In the present embodiment, the four conductive connection members 51 are coupled to each other by a moving mechanism 60 (to be described later). The four conductive connection members 51 are collectively movable in the Y direction by the moving mechanism 60. The four conductive connection members 51 are collectively inserted between the four device bus bars 12 and the four battery bus bars 22 from the Y direction by the moving mechanism 60.

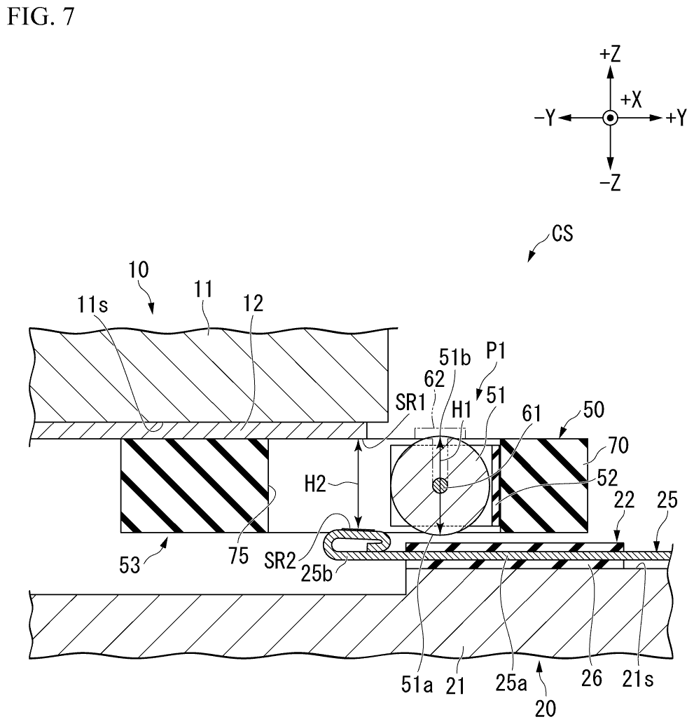

In the present embodiment, the conductive connection member 51 has a columnar shape having an axis along the X direction. The maximum thickness H1 of the conductive connection member 51 in the Z direction is larger than the minimum distance H2 between the device bus bar 12 and the battery bus bar 22 (see FIG. 7). The minimum distance H2 is, for example, the distance between the receiving surface SR1 of the device bus bar 12 and the receiving surface SR2 of the leaf spring 25b of the battery bus bar 22. When the maximum thickness H1 is larger than the minimum distance H2, when the conductive connection member 51 is inserted between the device bus bar 12 and the battery bus bar 22 from the Y direction, the conductive connection member 51 abuts the leaf spring 25b to elastically deform the leaf spring 25b in the −Z direction. That is, the conductive connection member 51 elastically deforms the leaf spring 25b in the −Z direction so as to increase the minimum distance H2.

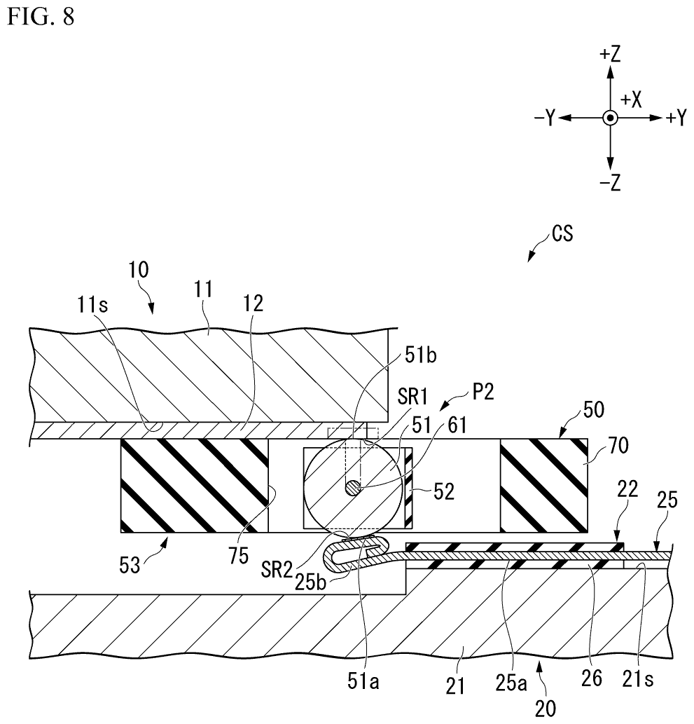

In the present embodiment, each of the conductive connection members 51 has a curved surface 51a that abuts the leaf spring 25b of the battery bus bar 22 (see FIG. 8). The curved surface 51a of the conductive connection member 51 is an arc-shaped curved surface protruding toward the leaf spring 25b of the battery bus bar 22 in a state where the conductive connection member 51 is inserted between the device bus bar 12 and the battery bus bar 22 from the Y direction. When the conductive connection member 51 has the curved surface 51a, a contact area between the conductive connection member 51 and the battery bus bar 22 is limited to a certain area or less.

Similarly, each of the conductive connection members 51 has a curved surface 51b that abuts the device bus bar 12 (see FIG. 8). The curved surface 51b of the conductive connection member 51 is an arc-shaped curved surface protruding toward the device bus bar 12 in a state where the conductive connection member 51 is inserted between the device bus bar 12 and the battery bus bar 22 from the Y direction. When the conductive connection member 51 has the curved surface 51b, the contact area between the conductive connection member 51 and the device bus bar 12 is limited to a certain area or less.

### Insulating Cover

The insulating cover 52 is an insulating member that electrically insulates the corresponding conductive connection member 51 from another conductive connection member 51. In the present embodiment, four insulating covers 52 are arranged corresponding to the four conductive connection members 51. Each insulating cover 52 has a first portion 52a, a second portion 52b, and a third portion 52c.

The first portion 52a is arranged on the +Y direction side of the corresponding conductive connection member 51. The first portion 52a is a plate along the X direction and the Z direction. The second portion 52b is arranged on the +X direction side of the corresponding conductive connection member 51. The second portion 52b is a plate along the Y direction and the Z direction. The second portion 52b is connected to the +X direction side-end of the first portion 52a. The third portion 52c is arranged on the −X direction side of the corresponding conductive connection member 51. The third portion 52c is a plate along the Y direction and the Z direction. The third portion 52c is connected to the −X direction side-end of the first portion 52a. In the present embodiment, a U-shaped insulating wall surrounding the conductive connection member 51 from three directions is formed by the first portion 52a, the second portion 52b, and the third portion 52c.

### Holder

The holder 53 is a member attached to the device 11 or the battery pack 21. In the present embodiment, the holder 53 is attached to the device 11 by a fixing member (e.g., bolt) (not illustrated). The holder 53 holds the connecting conductor 51U so as to be movable in the Y direction in a state of being attached to the device 11. The holder 53 includes, for example, the moving mechanism 60 and a housing 70.

### Moving Mechanism

First, the moving mechanism 60 will be described. The moving mechanism 60 is a mechanism that moves the connecting conductor 51U in the Y direction. In the present embodiment, the moving mechanism 60 is a mechanism that collectively moves the four conductive connection members 51 in the Y direction. The moving mechanism 60 includes, for example, a coupler 61 and an external force receiver 62.

### Coupler

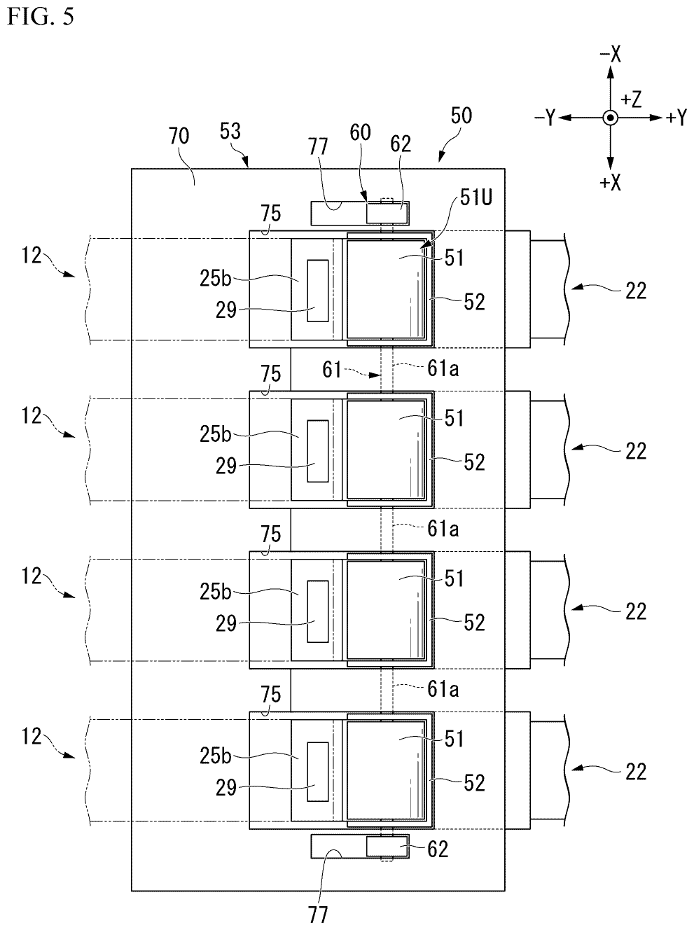

FIG. 5 is a plan view for describing the connection unit 50.

The coupler 61 is a member that couples the four conductive connection members 51. The coupler 61 includes, for example, a plurality of shafts 61a provided between two conductive connection members 51 adjacent to each other in the X direction. The shaft 61a connects two conductive connection members 51 adjacent to each other in the X direction. With such a constitution, the four conductive connection members 51 are connected by the coupler 61. Note that the coupler 61 is not limited to the above example, and may be one shaft member or the like penetrating the four conductive connection members 51 in the X direction.

The coupler 61 is formed of an insulating material. Since the coupler 61 is formed of an insulating material, the four conductive connection members 51 are electrically insulated from each other. In the present embodiment, the four insulating covers 52 described above are attached to the coupler 61.

### External Force Receiver

The external force receiver 62 is a portion that receives an external force for moving the connecting conductor 51U in the Y direction. The external force may be a manual force of an operator who assembles the assembly 1 or may be a force of a device used when assembling the assembly 1. The external force receiver 62 is provided, for example, at the +X direction-end and the −X direction-end of the coupler 61. In the present embodiment, the external force receiver 62 is a protrusion protruding in the +Z direction from the end of the coupler 61.

### Housing

Next, referring back to FIG. 3, the housing 70 will be described. The housing 70 is a housing that houses most of the conductive connection members 51 and most of the moving mechanism 60. In the present embodiment, the housing 70 is fixed to the device 11 by a fixing member (e.g., bolt) (not illustrated), whereby the holder 53 is attached to the device 11. The housing 70 includes, for example, a base 71 and a cover 72.

As illustrated in FIG. 4, the base 71 is located on the −Z direction side of the moving mechanism 60. The base 71 has, for example, a plurality of openings 75a and a plurality of depressions 76.

Each opening 75a is provided in a region overlapping the conductive connection member 51 and the insulating cover 52 when viewed in the Z direction. Each opening 75a penetrates the base 71 in the Z direction. Part of the conductive connection member 51 and part of the insulating cover 52 are accommodated in the opening 75a. In the present embodiment, the −Z direction-side end of the conductive connection member 51 protrudes from the opening 75a toward the −Z direction side.

The length of the opening 75a in the Y direction is a size that allows the conductive connection member 51 to move between a first position P1 and a second position P2 in the Y direction. The first position P1 is a position where the conductive connection member 51 is detached from between the device bus bar 12 and the battery bus bar 22 (see FIG. 7). The second position P2 is a position where the conductive connection member 51 is inserted between the device bus bar 12 and the battery bus bar 22 (see FIG. 8).

Each depression 76 is provided in a region overlapping the coupler 61 when viewed in the Z direction. Each depression 76 accommodates part of the coupler 61. Each depression 76 has a support surface 76a that supports the coupler 61 from the −Z direction side. The support surface 76a is, for example, a plane along the X direction and the Y direction. In the present embodiment, the moving mechanism 60 is movable in the Y direction between the first position P1 and the second position P2 in a state where the coupler 61 is supported by the support surface 76a.

The cover 72 is located on the +Z direction side of the moving mechanism 60. The cover 72 includes, for example, a plurality of openings 75b and a plurality of through holes 77.

Each opening 75b is provided in a region overlapping the conductive connection member 51 and the insulating cover 52 when viewed in the Z direction. Each opening 75b penetrates the cover 72 in the Z direction. Part of the conductive connection member 51 and part of the insulating cover 52 are accommodated in the opening 75b. In the present embodiment, the +Z direction side-end of the conductive connection member 51 protrudes from the opening 75b toward the +Z direction side. The length of the opening 75b in the Y direction is a size that allows the conductive connection member 51 to move between the first position P1 and the second position P2. In the present embodiment, the opening 75 of the housing 70 is formed by the opening 75a of the base 71 and the opening 75b of the cover 72.

Each through hole 77 is provided in a region overlapping the external force receiver 62 when viewed in the Z direction. The external force receiver 62 is exposed to protrude to the outside of the housing 70 through the through hole 77. The length of the through hole 77 in the Y direction is a size that allows the conductive connection member 51 to move between the first position P1 and the second position P2 in the Y direction.

### 3. Method of Manufacturing Assembly

Next, a method of manufacturing the assembly 1 will be described.

FIGS. 6 to 8 are cross-sectional views for describing the method of manufacturing the assembly 1. In the present embodiment, the device bus bar 12 is attached to the device 11 to form the device unit 10. In addition, the battery bus bar 22 is attached to the battery pack 21 to form the battery unit 20. Then, the connection unit 50 is attached to the device 11 using a fixing member (not illustrated) or the like, before the device unit 10 and the battery unit 20 are fixed using the fixing member 40. At this time, the plurality of conductive connection members 51 are arranged at the first position P1.

Next, as illustrated in FIG. 6, the device unit 10 and the battery unit 20 are combined. At this time, the plurality of conductive connection members 51 are still arranged at the first position P1.

Next, as illustrated in FIG. 7, the device unit 10 and the battery unit 20 are fixed using the fixing member 40. At this time, the plurality of conductive connection members 51 are still arranged at the first position P1.

Next, as illustrated in FIG. 8, by applying an external force to the external force receiver 62, the plurality of conductive connection members 51 are collectively moved in the −Y direction by the moving mechanism 60. At this time, each conductive connection member 51 abuts the leaf spring 25b of the battery bus bar 22. Then, each of the conductive connection members 51 is inserted between the device bus bar 12 and the leaf spring 25b of the battery bus bar 22 while elastically deforming the leaf spring 25b of the battery bus bar 22 in the −Z direction. As a result of this insertion, the −Z direction-end of each of the conductive connection members 51 abuts the leaf spring 25b of the battery bus bar 22, and the +Z direction-end of each of the conductive connection members 51 abuts the device bus bar 12. As a result, the device bus bar 12 and the battery bus bar 22 are electrically connected via the conductive connection member 51.

### 4. Advantage

In the present embodiment, the connection structure CS includes the device conductor 12U, the battery conductor 22U, and the connecting conductor 51U. The device conductor 12U is connected to the device 11. The battery conductor 22U is connected to the battery pack 21. The battery conductor 22U is separated from the device conductor 12U in the −Z direction. The connecting conductor 51U electrically connects the device conductor 12U and the battery conductor 22U by being inserted between the device conductor 12U and the battery conductor 22U from the Y direction in a state where the device 11 and the battery pack 21 are fixed. According to such a constitution, the device 11 and the battery pack 21 are fixed first, and in a state where the positional relationship between the device 11 and the battery pack 21 is stable, the device 11 and the battery pack 21 can be electrically connected by a simple operation from the Y direction using the connecting conductor 51U later. For this reason, for example, as compared with a structure in which a terminal of the device 11 and a terminal of the battery pack 21 are directly attached and detached, an event such as a half-fitted terminal is less likely to occur, and it is possible to reduce the burden of checking for such an event. When such a burden can be reduced, improvement in assemblability is easily achieved.

In the present embodiment, the battery conductor 22U has the leaf spring 25b that is elastically deformable in the −Z direction. The connecting conductor 51U is inserted between the device conductor 12U and the leaf spring 25b of the battery conductor 22U from the Y direction in a state where the device 11 and the battery pack 21 are fixed. Then, the connecting conductor 51U electrically connects the device conductor 12U and the leaf spring 25b in a state where the leaf spring 25b is elastically deformed. When such an elastically deformable leaf spring 25b exists, it is easy to absorb component tolerance and appropriately secure the contact pressure of the conductor.

In the present embodiment, the connection structure CS further includes the holder 53. The holder 53 is attached to the device 11 and holds the connecting conductor 51U so as to be movable in the Y direction. When such a holder 53 is provided, the connecting conductor 51U is movable in the Y direction while being supported by the device 11 via the holder 53. For this reason, the position of the connecting conductor 51U is easily stabilized when moving in the Y direction. When the position of the connecting conductor 51U is easily stabilized, improvement in assemblability is more easily achieved.

In the present embodiment, the connecting conductor 51U includes a plurality of conductive connection members 51 arranged side by side in the X direction and electrically connecting the plurality of device bus bars 12 and the plurality of battery bus bars 22. The holder 53 includes the moving mechanism 60 that collectively moves the plurality of conductive connection members 51 in the Y direction. When such a moving mechanism 60 is provided, the plurality of device bus bars 12 and the plurality of battery bus bars 22 can be collectively connected. When such collective connection is possible, improvement in assemblability is even more easily achieved.

The connecting conductor 51U has the curved surface 51a that abuts the battery conductor 22U in a state of being inserted between the device conductor 12U and the battery conductor 22U from the Y direction. When such a curved surface 51a is provided, the contact area between the conductive connection member 51 and the battery bus bar 22 is limited to a certain area or less. When the contact area is reduced, resistance when the conductive connection member 51 is moved in the Y direction can be reduced. When the resistance can be reduced, the insertion and removal performance can be improved, and improvement in assemblability can be more easily achieved. In addition, when the conductive connection member 51 has the curved surface 51a, it is possible to curb scraping of the conductive connection member 51 and deformation of the conductive connection member 51 as compared with a case where a conductive connection member having an acute angle is provided.

### 5. Modification

Next, some modifications of the first embodiment will be described. Note that the constitution other than that described below in each modification is the same as the constitution of the first embodiment described above.

### 5.1 First Modification

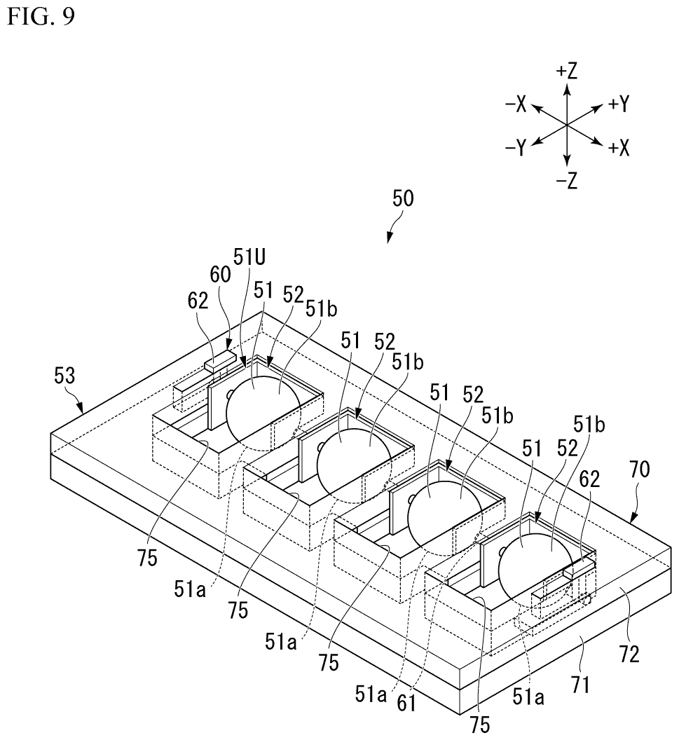

FIG. 9 is a perspective view illustrating a connection unit 50 of a first modification. In the present modification, a conductive connection member 51 is formed in a spherical shape. The conductive connection member 51 having such a shape can also have a curved surface 51a and a curved surface 51b as in the first embodiment.

### 5.2 Second Modification

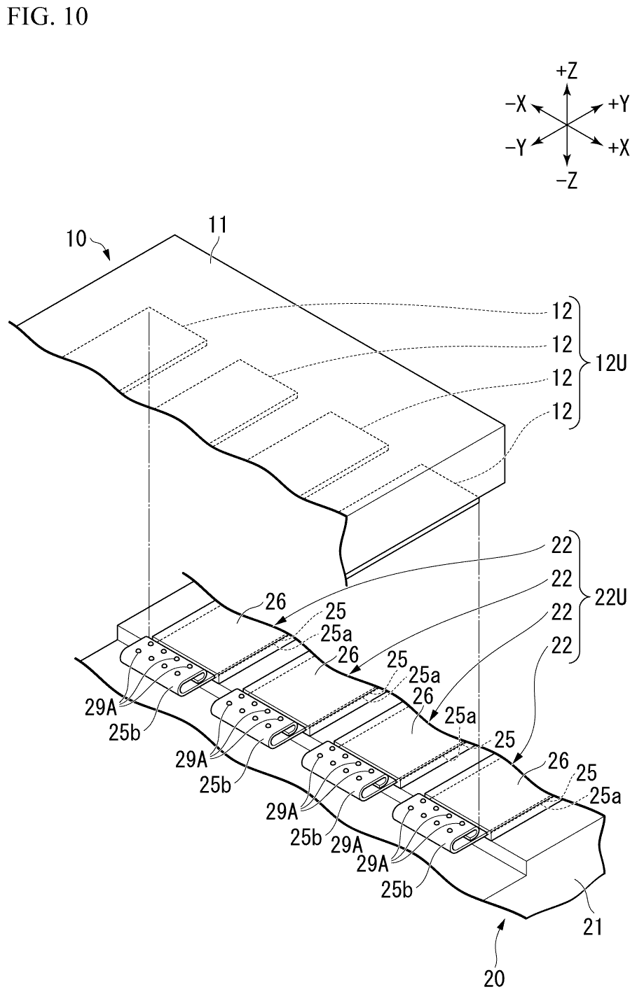

FIG. 10 is a perspective view for describing a connection structure CS of a second modification. In the present modification, a leaf spring 25b of a battery bus bar 22 has a plurality of small protrusions 29A instead of the protrusion 29. When such a plurality of protrusions 29A are provided, even when a conductive connection member 51 is inclined with respect to the leaf spring 25b due to component tolerance or the like, it is easy to stably secure the electrical connection between the leaf spring 25b and the conductive connection member 51.

### 5.3 Third Modification

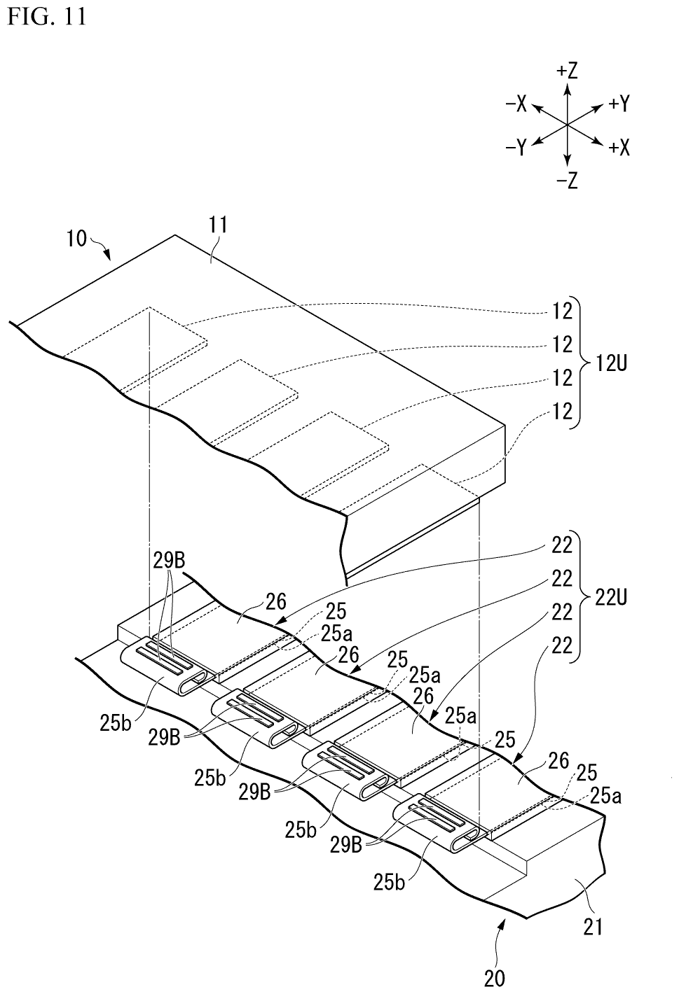

FIG. 11 is a perspective view for describing a connection structure CS of a third modification. In the present modification, a leaf spring 25b of a battery bus bar 22 has a pair of protrusions 29B instead of the protrusion 29. The pair of protrusions 29B are arranged so as to be spaced away from each other in the Y direction. Each of the pair of protrusions 29B protrudes in the +Z direction.

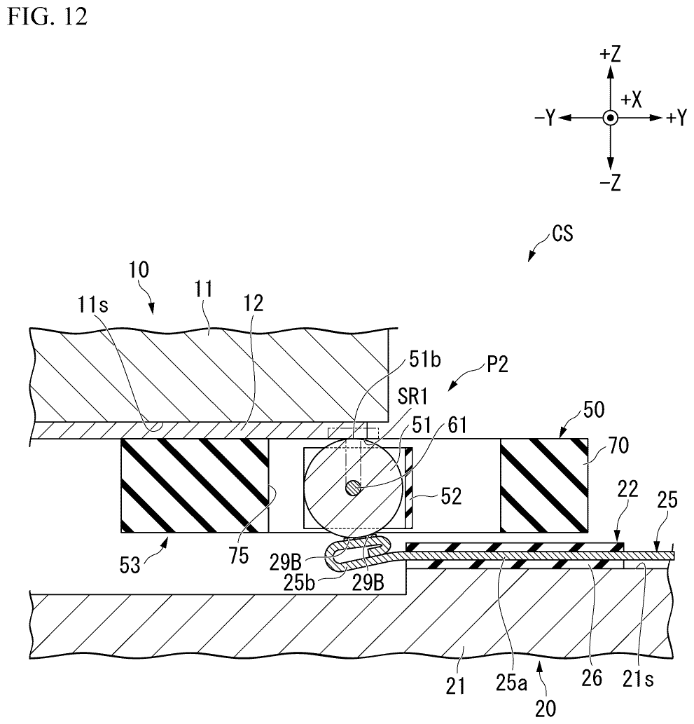

FIG. 12 is a cross-sectional view for describing the connection structure CS of the third modification. In the present modification, a conductive connection member 51 moved to the second position P2 is fitted between the pair of protrusions 29B. When such protrusions 29B are provided, the electrical connection between the leaf spring 25b and the conductive connection member 51 can be easily secured more stably. In addition, when such protrusions 29B are provided, it can be regarded that conduction is ensured by confirming that the conductive connection member 51 goes over one protrusion 29B. This further easily achieves improvement in assemblability.

### 5.4 Fourth Modification

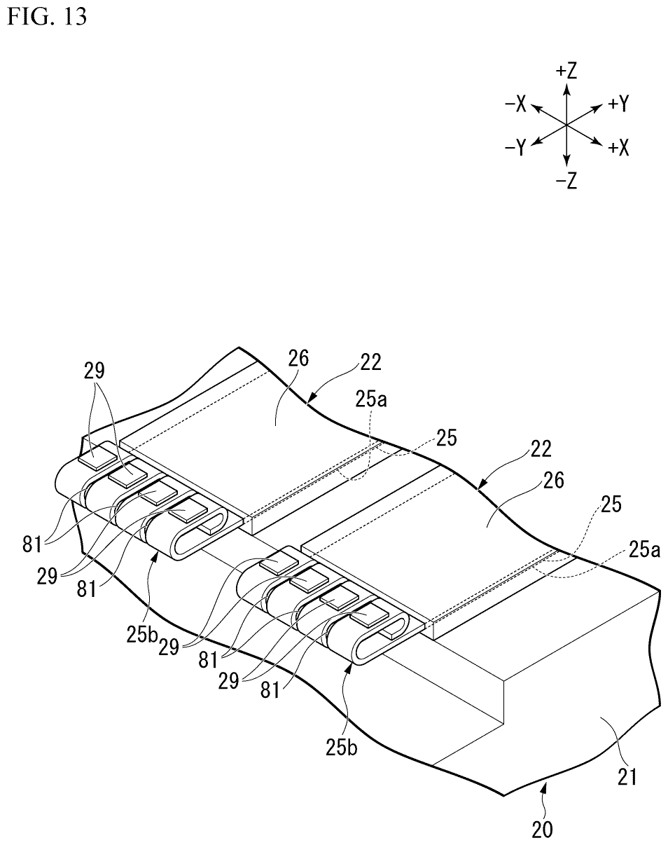

FIG. 13 is a perspective view for describing a connection structure CS of a fourth modification. In the present modification, a leaf spring 25b of a battery bus bar 22 has one or more slots 81. The leaf spring 25b is divided into a plurality of portions in the X direction by the slot 81. When the slot 81 is provided, the leaf spring 25b is easily elastically deformed in the −Z direction when the conductive connection member 51 abuts therewith. When the leaf spring 25b is easily elastically deformed in the −Z direction, a force (insertion force) required for the movement of the conductive connection member 51 in the Y direction can be reduced.

### 5.5 Fifth Modification

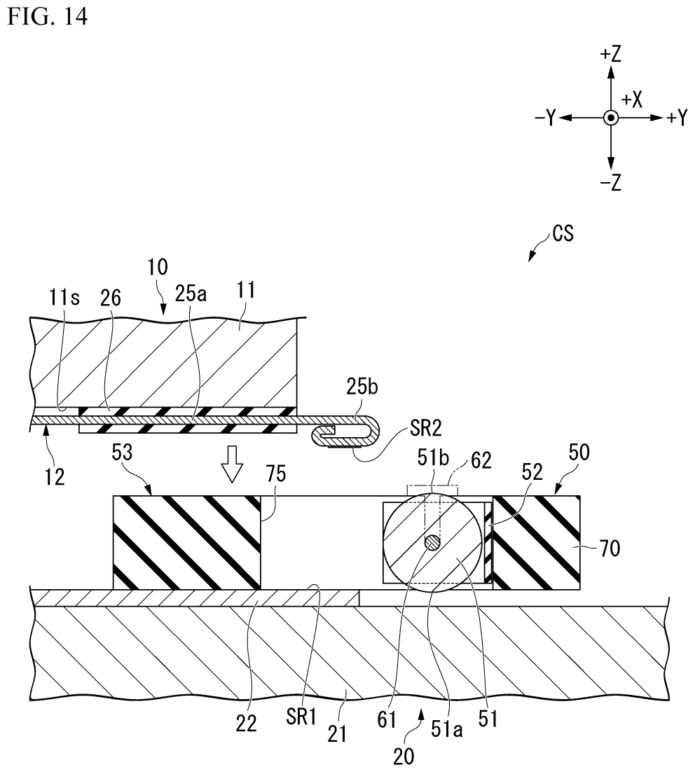

FIG. 14 is a cross-sectional view for describing a connection structure CS of a fifth modification. In the present modification, a connection unit 50 is attached to a battery pack 21 instead of a device 11. A device bus bar 12 includes a leaf spring 25b that is elastically deformable in the +Z direction. Even in such a constitution, by moving a connecting conductor 51U in the Y direction, the connecting conductor 51U can be inserted between a device conductor 12U and a battery conductor 22U. In the present modification, a battery bus bar 22 is an example of the “first conductor”. A device bus bar 12 is an example of the “second conductor”. Note that the constitution of the present modification may be applied in combination with the first to fourth modifications described above.

### Second Embodiment

Next, a second embodiment will be described. The second embodiment is different from the first embodiment in that a conductive connection member 50A is provided instead of the connection unit 50. Note that the constitution other than that described below in the second embodiment is the same as the constitution of the first embodiment described above.

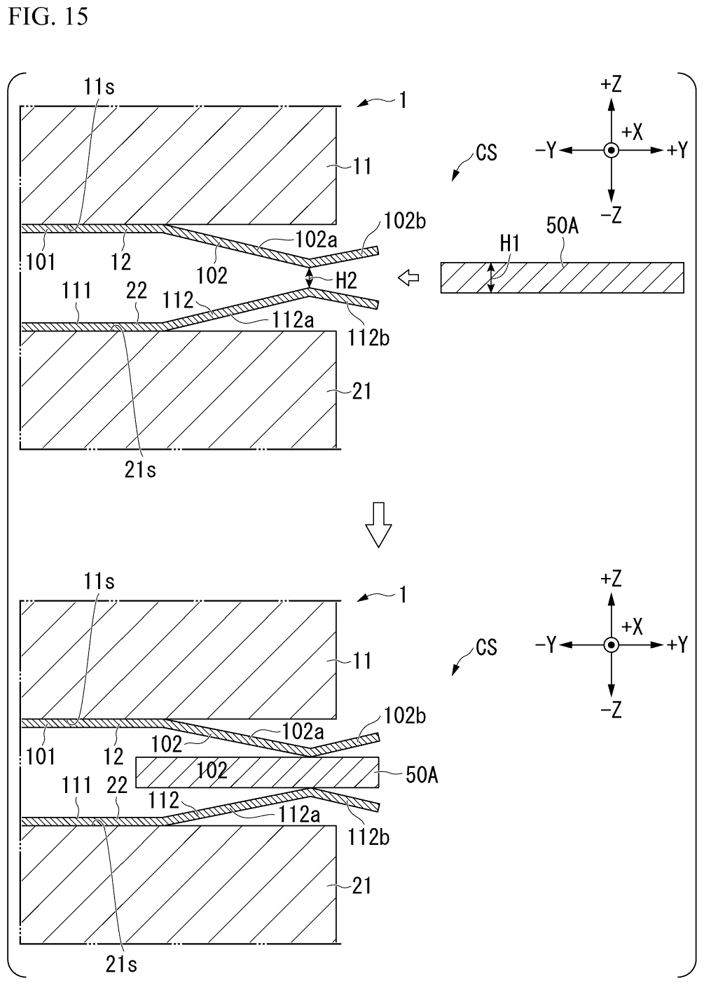

FIG. 15 is a cross-sectional view illustrating an assembly 1 of a second embodiment. In the present embodiment, a device bus bar 12 includes a flat plate 101 and a leaf spring 102. The flat plate 101 extends in the Y direction along an installation surface 11s of a device 11. The leaf spring 102 has a first portion 102a and a second portion 102b. The first portion 102a extends obliquely in the −Z direction from the flat plate 101. The second portion 102b extends obliquely in the +Z direction from the first portion 102a. The leaf spring 102 is elastically deformable in the +Z direction.

Similarly, a battery bus bar 22 includes a flat plate 111 and a leaf spring 112. The flat plate 111 extends in the Y direction along an installation surface 21s of a battery pack 21. The leaf spring 112 has a first portion 112a and a second portion 112b. The first portion 112a extends obliquely in the +Z direction from the flat plate 111. The second portion 112b extends obliquely from the first portion 112a in the −Z direction. The leaf spring 112 is elastically deformable in the −Z direction.

In the present embodiment, the conductive connection member 50A is a metal flat plate. A thickness H1 of the conductive connection member 50A in the Z direction is larger than a minimum distance H2 between the device bus bar 12 and the battery bus bar 22. The minimum distance H2 is, for example, the minimum distance between the leaf spring 102 of the device bus bar 12 and the leaf spring 112 of the battery bus bar 22.

When the conductive connection member 50A is inserted between the device bus bar 12 and the battery bus bar 22 from the Y direction, the conductive connection member 50A abuts the leaf spring 102 of the device bus bar 12 and the leaf spring 112 of the battery bus bar 22. Then, the conductive connection member 50A is sandwiched between the leaf spring 102 of the device bus bar 12 and the leaf spring 112 of the battery bus bar 22 in a state where the leaf spring 102 of the device bus bar 12 is elastically deformed in the +Z direction and the leaf spring 112 of the battery bus bar 22 is elastically deformed in the −Z direction. The conductive connection member 50A is sandwiched between the leaf spring 102 of the device bus bar 12 and the leaf spring 112 of the battery bus bar 22, thereby electrically connecting the device bus bar 12 and the battery bus bar 22. The conductive connection member 50A is an example of the “third conductor”.

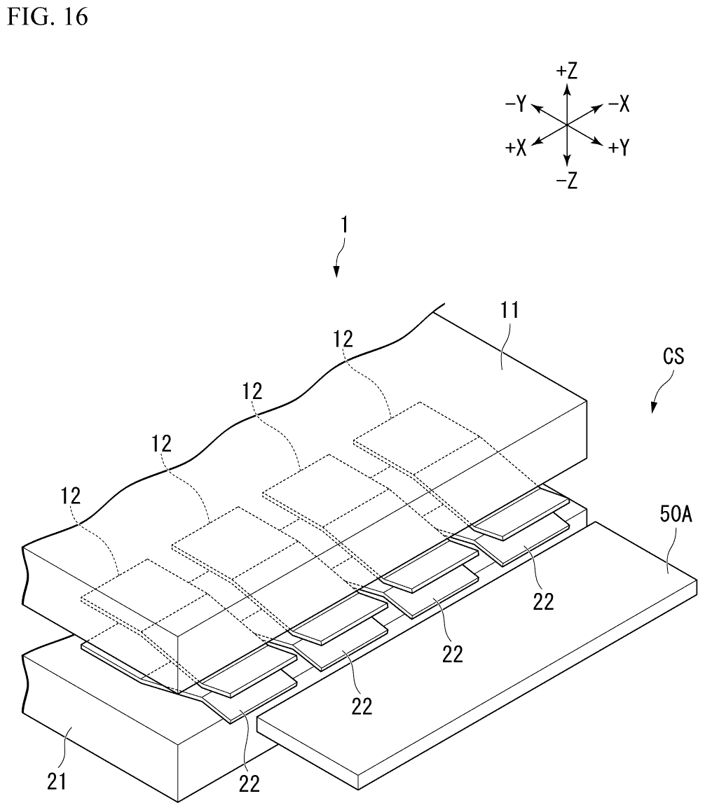

FIG. 16 is a perspective view illustrating an assembly 1 of the second embodiment. In the present embodiment, the conductive connection member 50A has a rectangular shape extending in the X direction. The conductive connection member 50A is sandwiched between a plurality of device bus bars 12 and a plurality of battery bus bars 22, and collectively electrically connects the plurality of device bus bars 12 and the plurality of battery bus bars 22.

Note that the conductive connection member 50A may be a member that connects one device bus bar 12 and one battery bus bar 22 instead of the above example. In addition, the conductive connection member 50A may be a member that connects a first number of device bus bars 12, which is one or more, and a second number of battery bus bars 22, which is larger than the first number. In addition, the conductive connection member 50A may be a member that connects a first number of battery bus bars 22, which is one or more, and a second number of device bus bars 12, which is larger than the first number.

Several embodiments and modifications have been described above. Note, however, that the embodiments and modifications are not limited to the examples described above. For example, the structure of the assembly 1 and the connection structure CS described above may be applied to a combination (any combination of first module and second module) other than the device 11 and the battery pack 21. The device 11 is an example of a “first module”. The battery pack 21 is an example of a “second module”. However, both the “first module” and the “second module” may be the same type of device. Alternatively, the “first module” and the “second module” may be different types of devices. Alternatively, both the “first module” and the “second module” may be a battery pack.

In the above-described embodiments, the first direction is a direction from the device 11 toward the battery pack 21. The second direction is a direction intersecting the direction from the device 11 toward the battery pack 21. Note that the first direction and the second direction are not limited to the above example. For example, the device bus bar 12 may extend from the device 11 and be bent, and the battery bus bar 22 may extend from the battery pack 21 and be bent. In this case, the device bus bar 12 and the battery bus bar 22 may face each other in a direction different from the direction from the device 11 toward the battery pack 21. That is, the first direction from the device bus bar 12 toward the battery bus bar 22 does not have to coincide with the direction from the device 11 toward the battery pack 21.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description and is only limited by the scope of the appended claims.

### INDUSTRIAL APPLICABILITY

According to the present disclosure, improvement in assemblability can be easily achieved.

### BRIEF DESCRIPTION OF THE REFERENCE SYMBOLS

1 Assembly
10 Device unit
11 Device
12 Device bus bar
20 Battery unit
21 Battery pack
22 Battery bus bar
40 Fixing member
50 Connection unit
51 Conductive connection member
51a Curved surface
51b Curved surface
52 Insulating cover
53 Holder
61 Coupler
62 External force receiver
70 Housing
CS Connection structure
CSa Connector

What is claimed is:

1. A connection structure for electrically connecting a device and a battery pack, the connection structure comprising:
a first conductor connected to one of the device and the battery pack;
a second conductor connected to the other of the device and the battery pack and arranged so as to be spaced away from the first conductor in a first direction; and
a third conductor configured to electrically connect the first conductor and the second conductor by being inserted between the first conductor and the second conductor from a second direction intersecting the first direction in a state where the device and the battery pack are fixed.

2. The connection structure according to claim 1, wherein
the second conductor includes a receiver that is elastically deformable in the first direction, and
the third conductor is configured to electrically connect the first conductor and the receiver by being inserted between the first conductor and the receiver of the second conductor from the second direction in a state where the device and the battery pack are fixed, and elastically deforming the receiver.

3. The connection structure according to claim 1, further comprising
a holder attached to the device or the battery pack and holding the third conductor movably in the second direction.

4. The connection structure according to claim 1, further comprising
a moving mechanism that is configured to move the third conductor,
wherein the first conductor includes a plurality of first conductive members arranged side by side in a third direction intersecting the first direction and the second direction,
the second conductor includes a plurality of second conductive members arranged side by side in the third direction,
the third conductor includes a plurality of third conductive members arranged side by side in the third direction and configured to electrically connect the plurality of first conductive members and the plurality of second conductive members, and
the moving mechanism collectively moves the plurality of third conductive members in the second direction.

5. The connection structure according to claim 1, wherein
the third conductor has a curved surface that abuts the second conductor in a state of being inserted between the first conductor and the second conductor from the second direction.

6. An assembly comprising:
a device;
a battery pack; and
a connection structure that is configured to electrically connect the device and the battery pack,
wherein the connection structure includes
a first conductor connected to one of the device and the battery pack,
a second conductor connected to the other of the device and the battery pack and arranged so as to be spaced away from the first conductor in a first direction, and
a third conductor configured to electrically connect the first conductor and the second conductor by being inserted between the first conductor and the second conductor from a second direction intersecting the first direction in a state where the device and the battery pack are fixed.
